(19) United States
(12) Patent Application Publication
(10) Pub. No.: US 2010/0031070 A1
(43) Pub. Date: Feb. 4, 2010

(54) POWER SUPPLY SYSTEM, SERVER, POWER SUPPLY METHOD, PROGRAM, AND STORAGE MEDIUM

(76) Inventor: HIROSHI TOMOMITSU, Tokyo (JP)

Correspondence Address: Mr. Jackson Chen, 6535 N. STATE HWY 161, IRVING, TX, 75039, US

(21) Appl. No.: 12/507,198

(22) Filed: Jul. 22, 2009

(30) Foreign Application Priority Data
Jul. 30, 2008 (JP) 2008-196852

(51) Int. Cl. G06F 1/26

(52) U.S. Cl. 713/300

(57) ABSTRACT

Provided are a power supply system, a server, a power supply method a program, and a storage medium which enable wasteless and efficient PoE power supply to a device that is powered through a LAN. The power supply system comprises a LAN switch connected to the LAN to perform the PoE power supply to the device through the LAN and a server for determining whether or not the PoE power supply is to be performed.

The present application is based upon and claims the benefit of priority from Japanese patent application No. 2008-196852, filed on Jul. 30, 2008, the disclosure of which is incorporated herein in its entirety by reference.

### BACKGROUND OF THE INVENTION

1. Field of the Invention

The present invention relates to a power supply system, a server, a power supply method, a program, and a storage medium.

2. Description of the Related Art

In an internet protocol (IP) telephone network system (namely, IP: protocol which directly connects a computer to the Internet via a device such as a router or a gateway) and a corporate telephone system using a private branch exchange (PBX) network, all of telephone are constantly powered on, irrespective of an actual state of each telephone. A call control server of the IP telephone network system and the PBX need to be constantly activated, but all telephone sets (terminals) do not always need to be activated at night or on a holiday because a corporation or a company is substantially inactive or closed.

Accordingly, turning off the power of a terminal which is not used at night and on a holiday is very effective to save useless power consumption. As a result, an amount of power consumed by the entire system can be reduced.

Description is made in JP 2005-333410 A about an example of a telephone switching system having a power supply function.

The telephone exchange system described in JP 2005-333410 A is featured by a telephone switching apparatus which is capable of connecting, via a network, a plurality of IP telephone terminals and electronic devices corresponding to respective users who use the IP telephone terminals, and establishing connection with at least one network. Specifically, the telephone switching apparatus comprises a device-state monitor section for monitoring an on/off state of a power supply of the electronic device via the network, a power source management section for outputting a power-on command and a power-off command to the IP telephone terminal, and a power source management table. In the power source management table, power-on time and power-off time of the IP telephone terminal are preset by a manual operation of a user together with an attended/unattended state of the user who uses the IP telephone terminal. In addition, provision is made about a monitor device table for storing a correspondence between the electronic device and the IP telephone terminals. With this structure, the device-state monitor section causes the power management table to update and store the attended/unattended state of the user based on a monitoring result; while the power source management section outputs, based on the power management table, the power-on command and the power-off command to the IP telephone terminal.

It is stated that, according to the telephone switching system described in JP 2005-333410 A, a power supply state of a PC terminal corresponding to each of the IP telephone terminals is monitored so as to determine the attended/unattended state of the user thereof and the preset power-on time and the preset power-off time are referenced for controlling on/off of the power supply of each of the IP telephone terminals. This structure makes it possible to construct an IP telephone system which saves power and which is highly convenient to the user.

In addition, description is also made in JP 11-231977 A about an example of a remote control method with a power saving function.

The remote control method with a power saving function described in JP 11-231977 A is featured by a system in which a first information processing apparatus and at least one second information processing apparatus are connected via a network. Specifically, the first information processing apparatus outputs a control signal which specifies a power saving mode to the network at a first step. When a predetermined condition is satisfied, the at least one second information processing apparatus is shifted to the power saving mode in response to the control signal.

It is stated that, according to the remote control method with a power saving function described in JP 11-231977 A, setting and management of the power saving mode for the at least one second information processing apparatus are centrally managed and enable remote control of the power saving mode. As a result, the information processing system can be efficiently used in terms of power consumption.

Disclosure is made in JP 2006-94013 about an example of a PoE (Power Over Ethernet) system.

The PoE system disclosed in JP 2006-94013 A is constituted by connecting via an Ethernet (registered trademark) cable (namely, LAN cable), an output terminal for inputting/outputting information and supplying power and an input terminal for inputting/outputting information and receiving power. In the PoE system, power supply is started after negotiation between the output terminal and the input terminal. More specifically, the negotiation is conducted between the output terminal and the input terminal by transmitting a specified response request signal from the output terminal to the input terminal, by confirming that the input terminal is capable of receiving power, and by transmitting a response signal from the input terminal to the output terminal in response to the specified response request signal.

It is stated that, according to the PoE system described in JP 2006-94013 A, the negotiation between the output terminal and the input terminal is conducted so as to detect whether or not the connected terminal can receive power through the LAN cable and whether or not the connected terminal can be accurately operated by PoE power supply. With this structure, it is possible to avoid any risk of supplying power to a terminal which cannot be operated through the LAN cable by the PoE power supply. At any rate, the PoE power supply is continued as long as the input terminal is connected to the LAN cable and is interrupted only when disconnection from the LAN cable is detected by the output terminal. No consideration is made at all about saving power consumption in the PoE system which includes IP telephones and personal computers and about controlling the input terminal which is connected to the LAN cable and which is put into an inactive state.

### SUMMARY OF THE INVENTION

An exemplary object of the present invention is to provide a power supply system, a server, a power supply method, a program, and a storage medium each of which enables wasteless and efficient PoE power supply to a device that is powered through a LAN.

According to a first aspect of the present invention, there is provided a power supply system, comprising a device which is connected to a LAN and which is powered through the LAN, a LAN switch which is connected between the LAN and the device and which switches Power-over-Ethernet (PoE) power supply to the device, and a server which controls the LAN switch to determine whether or not the LAN switch performs the PoE power supply to the device.

According to a second aspect of the present invention, there is provided a server comprising a controller unit which makes a decision about whether or not PoE power supply is to be performed and an interface circuit which sends a LAN switch a control instruction of indicating whether or not the PoE power supply is performed.

According to a third aspect of the present invention, there is provided a power supply method of performing PoE power supply through a LAN to a user device, comprising, in a server, making a decision about whether or not PoE power supply is to be performed, informing a LAN switch of performing the PoE power supply, and, in the LAN switch, switching the PoE power supply to control the PoE power supply to a user device through the LAN.

According to a fourth aspect of the present invention, there is provided a computer-readable program product, which causes a PoE server to perform PoE power supply to a user device through a LAN switch and a LAN cable, comprising making a decision about whether or not the PoE power supply is to be performed, and informing the LAN switch of performing the PoE power supply when the PoE power supply is performed.

According to the present invention, there is obtained a PoE power supply system, a server, a PoE power supply method, and a computer-readable program product each of which is effective to save PoE power.

### BRIEF DESCRIPTION OF THE DRAWINGS

The above-mentioned features and advantages of the present invention will be more apparent from the following description of exemplary embodiments taken in conjunction with the accompanying drawings, in which:

FIG. 1 is a block diagram illustrating an embodiment of a power supply system according to the present invention;

FIG. 2 illustrates an example of a port table used in the power supply system illustrated in FIG. 1;

FIG. 3 illustrates an example of an automatic control table used in the power supply system illustrated in FIG. 1;

FIG. 4 illustrates an example of a flow chart used in the power supply system illustrated in FIG. 1; and

FIG. 5 illustrates another example of a flow chart used in the power supply system illustrated in FIG. 1.

### DETAILED DESCRIPTION OF THE EXEMPLARY EMBODIMENTS

### <Specific Feature>

The present invention is featured in that electric power supply according to the Power over Ethernet (PoE) (registered trademark) standard, which would be abbreviated to PoE power supply in the instant specification, is halted or stopped to a device, such as an IP telephone, compliant with the PoE standard while such a device is not being used. As a result, the present invention is very effective to suppress useless electric power consumption and serves to save power consumption in a PoE power supply system. To achieve such power saving, the present invention is specifically featured in that a power supply on/off operation is executed at a preset time, by presuming an attended/unattended state of a user, and/or manually by a system administrator or the user.

To this end, the power supply system according to the present invention has a LAN switch (network line concentrator) connected to the device compliant with the PoE standard through a LAN cable to execute PoE power supply to the device and a server for controlling the LAN switch in order to determine whether or not the LAN switch executes the PoE power supply to the device.

As a result, the present invention implements a halt of the PoE power supply to an arbitrary terminal only during arbitrary times or hours. In this event, the device, such as the IP telephone or the like, may not be pulled off from the LAN cable when it is put into an inactive state and may not be plugged into the LAN cable when it is powered or put into an active state through the LAN cable.

<Configuration>

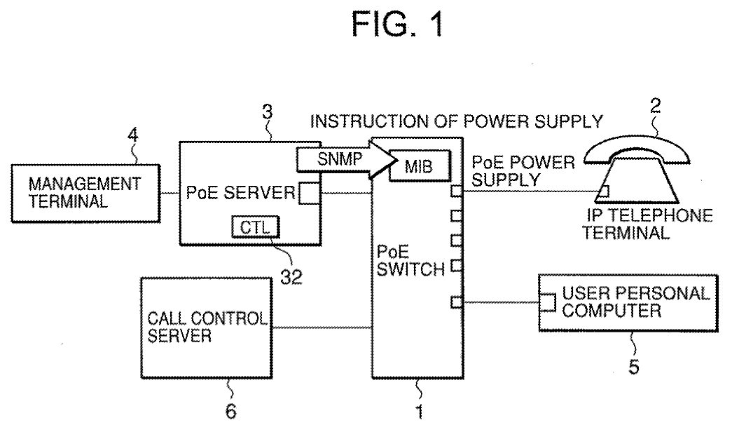

FIG. 1 is a block diagram illustrating an exemplary embodiment of a power supply system according to the present invention.

The power supply system illustrated in FIG. 1 includes a management terminal 4, a PoE server 3, a call control server 6, a PoE switch 1, an IP telephone terminal 2, and a user personal computer 5. The illustrated IP telephone terminal 2 and user personal computer 5 are assumed to be used by a single user in common and to be connected to the PoE switch 1 through LAN cables compliant with the PoE standard.

The PoE switch 1 has a plurality of ports or network interface cards (NIC) specified by rectangles in FIG. 1 and serves to concentrate lines of the device or devices included in an IP telephone system, and to transfer data between the PoE server 3 and the devices through the LAN cables. The illustrated PoE switch 1 also has a PoE power supply function of supplying electric power using the LAN cables for transmitting/receiving data. Thus, the PoE power supply is executed by the POE switch 1 to the devices through the LAN cables.

In FIG. 1, the IP telephone terminal 2 is powered by the PoE power supply compliant with the PoE standard and is put into an active state by the PoE power supply.

As shown in FIG. 1, the PoE switch 1 is also connected to the PoE server 3 which is specified by a controller (CTL) 32 and an interface circuit 34. The PoE server 3 issues, to the PoE switch 1, instructions of turning on or off the PoE power supply on a port-by-port basis. Responsive to the instructions, the PoE switch 1 controls the PoE power supply to a port specified by the instructions.

The PoE server 3 holds a setting file concerned with PoE control of the PoE switch 1. The setting file stores a policy for the PoE control and schedule information for automatic control in the form of a control or schedule program. Such a program may be recorded on a recording medium.

The instructions are issued from the PoE server 3 to the PoE switch 1. The instructions given to the PoE switch 1 are sent in accordance with the simple network management protocol (SNMP) and serve to change a management information base (MIB) held by the PoE switch 1 and, thereafter to be executed in the PoE switch 1.

The management terminal 4 connected to the PoE server 3 is used for an operation/management operation or work for the PoE server 3. An administrator of the IP telephone system can reference or update the setting file in the PoE server 1 through a PoE setting screen on the management terminal 4. This function allows the administrator to immediately give an instruction to control the PoE power supply to an arbitrary IP telephone terminal, and to register a setting for automatically giving a PoE control instruction for an arbitrary IP telephone terminal at an arbitrary time.

The user personal computer 5 may be, for example, a personal computer which is normally used by the user of the IP telephone terminal 2, and can give an instruction to the IP telephone terminal 2 to control the PoE Dower supply to the IP telephone terminal 2. Although the illustrated PoE server 3 is assumed not to control the PoE power supply to another IP telephone terminal (not shown in FIG. 1), a plurality of IP telephone terminals may be controlled by the PoE server 3 through the PoE switch 1 and the LAN cables.

The user may reference or update a part of the setting file in the PoE server 3 through the PoE setting screen displayed on the user personal computer 5. This function allows the user to immediately give an instruction to control the PoE power supply to the IP telephone terminal 2, and to register the setting for automatically giving the PoE control instruction for the IP telephone terminal 2 at an arbitrary time.

The call control server 6 performs a call control operation for each IP telephone terminal.

### <Description of Operation>

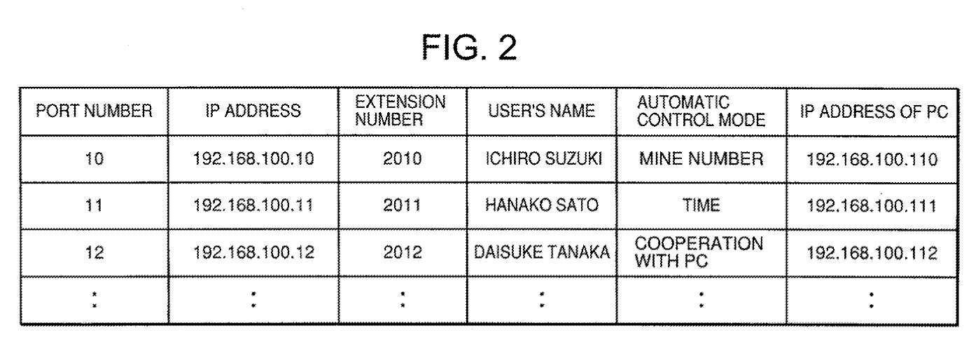

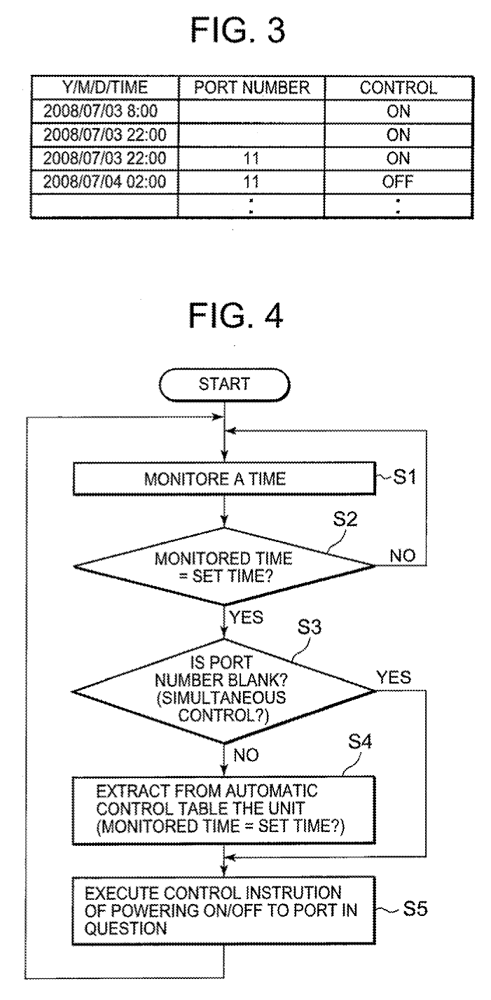

The PoE server 3 of FIG. 1 holds a port table illustrated in FIG. 2, and an automatic control table illustrated in FIG. 3.

FIG. 2 illustrates an example of the port table used in the power supply system illustrated in FIG. 1. FIG. 3 illustrates an example of the automatic control table used in the power supply system illustrated in FIG. 1.

The PoE server 3 executes the PoE power supply control in accordance with a processing flow illustrated in FIG. 4. Specifically, the PoE power supply control of the illustrated PoE server 3 is performed by monitoring a predetermined time set in the automatic control table illustrated in FIG. 3.

Referring to FIG. 4, description will be made about an operation of the power supply system which is illustrated in FIG. 1. Especially, the operation of the PoE server 3 will be mainly described in the following.

The PoE server 3 monitors a time (Step S1).

The PoE server 3 determines whether or not the monitored time arrives at the time set to the automatic control table (Step S2). When the PoE server 3 determines that the monitored time does not arrive at the set time (Step S2/N), the PoE server 3 returns to Step S1 to be put into a stand-by state. When the PoE server 3 judges that the monitored time arrives at the set time (Step S2/Y), the processing of the PoE server 3 proceeds to Step S3.

At Step S3, the PoE server 3 judges whether or not a port number of the port table (FIG. 3) is put into a blank state, as shown in the first and the second rows of FIG. 3. Herein, it is to be noted that the blank state of the port number indicates simultaneous control of the plurality of the ports.

When the PoE server 3 judges that the port number is put into the non-blank state (Step S3/N), the processing of the PoE server 3 proceeds from Step S3 to Step S4. The PoE server 3 gives access to a port number of the automatic control table at Step S4 to extract, from the automatic control table (FIG. 2), the port number at which the monitored time arrives at or is equal to the set or predetermined time. Thereafter, processing of the PoE server 3 proceeds from Step S4 to Step 5 where the PoE server 3 gives a control instruction of turning on/off or switching the PoE power supply to the port in question and then returns to Step 1. At Step S5, the control instruction is sent from the PoE server 3 to the PoE switch 1. As a result, the PoE switch 1 executes the PoE power supply to the port in question.

On the other hand, when the PoE server 3 judges that the port number is put into a non-blank state (Step S3/Y), the processing of the PoE server 3 proceeds from Step S3 to Step S5.

In this event, simultaneous control is executed about the plurality of the ports of the PoE switch 1 at Step S5.

As shown in FIG. 3, the port table stores therein a time (YEAR/MONTH/DAY/TIME) at which the control is executed, a target port number, and a content of the control (ON or OFF). According to the content, the PoE server 3 gives, to the PoE switch 1, the instruction of powering on or off the PoE power supply to the target port at the time when the monitored time arrives at the set time.

When the port number is blank or is not specified in the port table (FIG. 3), the PoE server 3 extracts, from the automatic control table (FIG. 2), the ports at which the automatic control mode is specified by or indicated as “TIME”. The PoE server 3 gives the instruction for all the extracted ports.

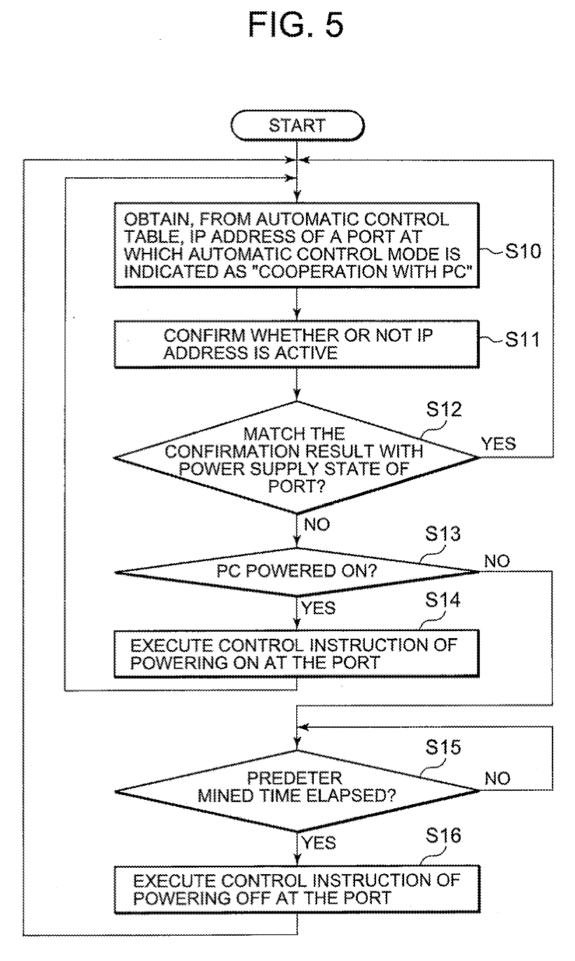

In FIG. 5, a processing of the PoE server 3 is executed in consideration of a user state in order to perform the PoE power supply to the device or devices connected to the PoE switch 1 through the LAN cable. Specifically, the PoE server 3 monitors an attended/unattended state of the user personal computer 5 usually used by the user of the IP telephone terminal 2 to presume the attended/unattended state of the user and to control the PoE power supply of the PoE switch 1. In other words, the PoE server 3 confirms whether or not the user personal computer 5 is put into an active state and the PoE power supply control is executed on the basis of the confirmation result.

Now, description will be made about the operation of the PoE server 3 with reference to FIG. 5. The PoE server 3 makes access to the automatic control table illustrated in FIG. 3 and extracts an IP address of a PC connected to a port in which the automatic control mode is indicated as “COOPERATION WITH PC” (Step S10).

Next, the PoE server 3 confirms whether or not the PC of the extracted IP address is put into an active state (Step S11) to obtain a confirmation result. Subsequently, the PoE server 3 judges whether or not the confirmation result matches with the power supply state of the port in question (Step S12).

When the PoE server 3 judges that the confirmation result matches with an actual power supply state of the port in question (Step S12(Y), the PoE server 3 returns to Step S10. On the other hand, when the PoE server 3 judges that the confirmation result does not match with the actual power supply state of the port in question (Step S12/N), the processing of the PoE server 3 is shifted from Step S12 to Step S13.

At Step S13, the PoE server 3 judges whether or not the PC is powered on. When the PoE server 3 judges that the PC is powered on (Step S13/Y), the processing of the PoE server 3 proceeds from Step S13 to Step S14.

At Step S14, the PoE server 3 gives the control instruction of powering on the PoE power supply to the port in question and, thereafter, the processing of the PoE server 3 returns to Step S10.

When the PoE server 3 judges that the PC is not powered on (Step S13/N), the processing of the PoE server 3 proceeds from Step S13 to Step S15. At Step S15, the PoE server 3 judges whether or not a predetermined time period has elapsed (Step S15). On judging that the predetermined time period has not elapsed (Step S15/N), the PoE server 3 is put into a stand-by state.

On the other hand, when the predetermined time period has elapsed (Step S15/Y), the processing of the PoE server 3 is moved from Step S15 to Step S16. At Step S16, the PoE server 3 sends the PoE switch 1 the control instruction of powering off the PoE power supply to the port in question and, thereafter, the processing of the PoE server 3 returns to Step S10.

To obtain the target port of the control, the PoE server 3 detects, from the automatic control table illustrated in FIG. 2, the IP address of the personal computer mainly used by the same user as that of the IP telephone terminal connected to the port in which the automatic control mode is indicated as “COOPERATION WITH PC”, and confirms whether or not the personal computer having the detected IP address is put into the active state. As a result, when no response is received from the corresponding personal computer and the predetermined time period has elapsed without any response, the PoE server 3 judges that the IP telephone terminal is unattended by the user. On the other hand, when any response is received from the personal computer the PoE server 3 judges that the user attends the personal computer. Based on the judgment result, the PoE power supply to the corresponding IP telephone terminal 2 is powered off or on.

Herein, it is to be noted that automatic PoE power supply control is not performed at the port at which the automatic control mode is indicated as “MAIN NUMBER”. This is based on the assumption that the port is always connected to an IP telephone terminal which is always kept available.

In addition to the automatic PoE power supply control based on the automatic control table and on the confirmation of whether or not the personal computer is active, it is possible to manually give an instruction for PoE power supply control.

Using the management terminal 4 of FIG. 1 the administrator of the IP telephone system can give an instruction to control the PoE power supply to each of all the IP telephone terminals 2 under management. Alternatively, using the user personal computer 5, the user of the IP telephone terminal 2 can give a PoE control instruction for the IP telephone terminal 2 used by himself/herself.

### Second Embodiment of the Invention

In the second embodiment of the IP telephone system, the PoE server 3 selects a proper power supply target terminal on the basis of information which is related to incoming calls and outgoing calls and which is held by the call control server 6. This structure makes it possible to implement more elaborate PoE power supply control.

### <Program and Storage Medium>

The power supply system and the PoE server 3 according to the present invention described above are operated in accordance with a program which may be stored in a recording medium as a computer-readable program product so as to cause a computer to execute a processing. As an example of the computer, a versatile computer, such as a personal computer or a work station, can be enumerated but the present invention is not limited thereto.

Specifically, the program according to the exemplary example of the present invention may be specified by a computer readable program which causes a computer to execute the procedure mentioned in relation to FIG. 3. In this event, the program in the PoE server 3 serves to automatically issue the control instruction of executing the PoE power supply to the PoE switch 1 by monitoring a time. As a result, the device is powered on due to the PoE power supply from the PoE switch 1 through the LAN cable when the time arrives at the set time.

Alternatively, the program according to the present invention may be specified by a computer readable program which causes the computer to execute the procedure mentioned in relation to FIG. 2. In this case, the program in the PoE server 3 serves to automatically issue the control instruction of executing the PoE power supply to the PoE switch 1 by assuming the attended/unattended state of each user. Thereafter, the PoE power supply is executed from the PoE switch 1 to each device through the LAN cable.

The program may cause the computer to execute the procedure of manually executing the PoE power supply from the PoE switch 1 to each device through the LAN cable.

In addition to any one of the above-exemplified programs, a program may be added such that procedures are executed in the manner mentioned in connection with FIG. 3. In this case, the program in the PoE server 3 extracts a port number which is not specified from the above-mentioned automatic control table and of which the automatic control mode is indicated as “TIME” from the port table and executes the PoE power supply to all of the extracted ports.

In addition to any one of the above-mentioned programs, the program may cause the computer to execute the procedures of: retrieving, by the PoE server, from the port table storing therein the port number, the IP address, the extension number, the user's name, the automatic control mode, and the IP address of the personal computer, the IP address of a personal computer used by the same user as a user of an IP telephone terminal connected to a port in which the automatic control mode is “COOPERATION WITH PC”; confirming, by the server, whether or not the personal computer having the IP address is active, determining, by the server, that the user is unattended when the corresponding personal computer does not respond to and a given period of time has elapsed or determining that the user is present when there is a response; and turning on/off, by the server, the PoE power supply to the corresponding IP telephone terminal based on a result of the determination.

In addition to any one of the above-mentioned programs, the program may cause the computer to execute the procedure of not performing, by the server, automatic control of the PoE power supply to the port in which the automatic control mode is indicated as “MAIN NUMBER” because the port is connected to an always available IP telephone terminal.

As a result, as long as there is a computer environment in which the program can be executed, the power supply system and the server according to the present invention can be implemented in any place.

Such a program may also be stored in a computer readable storage medium.

Examples of the storage medium that can be listed include computer readable storage media such as a compact disc read only memory (CD-ROM), a flexible disc (FD), a compact disc recordable (CD-R), and a digital versatile disk (DVD), semiconductor memories such as a flash memory, a random access memory (RAM), a read only memory (ROM), and a ferroelectric random access memory (FeRAM), and a hard disc drive (HDD).

The embodiments described above are only illustrative of the preferred embodiments of the present invention, and the present invention is not limited thereto. Various modifications and changes can be made in the invention without departing from the gist thereof.

### <Operation and Effect>

According to the embodiments, the electric power consumption of an IP telephone system can be reduced.

The following is a specific example. In a system including three hundred IP telephone terminals, when a power supply is turned off from 22 o'clock to 8 o'clock in the next morning in five days of a week, and all day long in two days of a week, it is possible to reduce 5,700 kWh per year, which is equivalent to an electric power cost of about ¥63,000 (63,000 yen) (estimated on the assumption that the electric power consumption of the IP telephone terminal is 4 W, and the electric power cost is ¥11/kWh) per year.

Thus, according to the embodiments, a significant electric power saving effect (including a CO₂ reducing effect) can be obtained without impairing the convenience of the IP telephone.

Now, the differences between the present invention and the inventions described in JP 2005-333410 A, JP 2006-94013 A, and JP 11-231977 A are described.

At first, it is to be noted that there are the three significant points of controlling the PoE power supply according to the PoE standard.

(a) No specific function may be added to each of powered devices.

(b) The PoE power supply control is applicable to all types of PoE-compliant powered devices.

(c) No network traffic is caused to occur for power source control between the PoE switch 1 and the powered devices.

The present invention includes the LAN or PoE switch which controls the PoE power supply in response to the instruction from the PoE server. The PoE server may give the instruction to control the PoE power supply at a set time, may presume the attended/unattended state of the user of the terminal device to give the PoE switch the instruction of controlling the PoE power supply, and/or may give the instruction of controlling the PoE power supply in response to a manual operation. In addition, the terminal device is activated/halted by switching the PoE power supply.

The advantages of the present invention are as follows. When the terminal device is not used, electric power consumption can be reduced (the electric power consumed by the terminal is completely cut off). With the instruction of switching the PoE power supply, the reactivation of the PoE powered devices can be simultaneously executed. By controlling the PoE power supply, (i) there is no need to add a function to the terminal, (ii) the PoE power supply control is applicable to all types of PoE terminals, and (iii) there is no increase in terminal traffic.

No disclosure is made in any of JP 2005-333410 A, JP 2006-94013 A, and JP 11-231977 about a method which uses a LAN or PoE switch which has the above-mentioned advantages (a) to (c) and which can control the PoE power supply.

Specifically, JP 2005-333410 A describes no LAN switch which controls the PoE power supply in accordance with an instruction issued from any PoE server. Although an instruction for power supply control is issued from a server at a set time, PoE power supply control is not performed. Though an attended/unattended state of a user is presumed in JP 2005-333410 A, no description is made at all about PoE power supply. In addition, there is no server that gives an instruction for PoE power supply control in response to a manual operation. An electric power halt mode is incomplete and, in particular, management after an electric power halt is impossible.

The invention described in JP 2006-94013 A does not have a configuration as disclosed in the present invention. Specifically, no consideration is made at all in JP 2006-94013 A about using a PoE server and a PoE switch to execute PoE power supply.

In the invention described in JP 11-231977 A, there is the server which gives the instruction to control the power supply at a set time, but PoE control is not performed. There is the server which gives the power supply control instruction in response to a manual operation, but PoE control is not performed. In response to the turning on/off of the power supply, the function and performance of the device are restricted, but complete activation/halt of the device is not performed.

Each of JP 2005-333410 A and JP 11-231977 A discloses that the object of the invention described therein is to achieve the effect of saving electric power for the power receiving device by any control method. However, in each of the inventions described in JP 2005-333410 A and JP 11-231977 A, the power receiving device merely switches to an operation in the “power saving mode”, and the supply of electric power is not completely cut off. Moreover, it is obvious that, in the invention described in JP 11-231977 A, the performance and function of the power receiving device degrade upon switching to the power saving mode. In addition, in the invention described in JP 2005-333410 A, unless the power receiving device continues to operate in the “power saving mode”, the instruction to turn on the power supply cannot be received. This causes such operational problems that not only the electric power saving effect is limited, but also the operation after the electric power halt cannot be managed.

Thus, unlike each of the inventions described in JP 2005-333410 A, JP 2006-94013 A, and JP 11-231977 A, the present invention completely cuts off the supply of electric power, and can therefore promise a significant electric power saving effect.

### <Industrial Availability>

An electric power saving method according to the present invention is also applicable to any device other than the IP telephone terminal 2 as long as the device receives a supply of electric power according to the PoE standard. For example, a wireless LAN access point, a Web camera, or the like can be considered. The power supply control instruction from the PoE server 3 to the PoE switch 1 can also be given using a TELNET (teletype network: a method of logging into a distant computer via a network) protocol instead of the SNMP protocol. In the case where the PoE switch does not support the PoE power supply control according to the SNMP protocol, the use of the TELNET protocol can be considered. Moreover, the present invention can be used in a power supply system or a server including devices which receive power from a LAN, such as an IP telephone terminal, a personal computer, a security camera, a security microphone, a security light, a wireless LAN, or a Web camera.

Now, exemplary examples of the present invention will be enumerated below.

A first exemplary example of the present invention is a power supply system, comprising:

a device which is connected to a LAN and which is powered through the LAN;

a LAN switch which is connected between the LAN and the device and which switches power supply to the device due to Power over Ethernet (PoE) to control the power supply to the device; and

a server which automatically supplies the LAN switch with instructions of performing the power supply due to the Power over Ethernet at a predetermined time instant.

A second exemplary example of the present invention is a power supply system, comprising:

a device which is connected to a LAN and which is powered through the LAN;

a LAN switch which is connected to the LAN and which switches power supply due to Power over Ethernet to control the power supply to the device; and

a server which presumes an attended/unattended state of a user and which automatically instructs the LAN switch to control the power supply due to the Power over Ethernet.

A third exemplary example of the present invention is a power supply system, comprising:

a device which is connected to a LAN and which is powered through the LAN;

a LAN switch which is connected to the LAN and which switches power supply due to the Power over Ethernet to control the power supply to the device; and

a server which allows a user to manually instruct the LAN switch to control the power supply due to the Power over Ethernet.

A fourth exemplary example of the present invention is a power supply system according to any one of the first through the third exemplary examples, wherein:

the server includes;
a port table storing therein a port number, an IP address, an extension number, a user's name, an automatic control mode, and the IP address of a personal computer; and
an automatic control table storing therein a time at which control is executed, a target port, and a content of the control; and

when the port number is not specified in the automatic control table, the server extracts ports in each of which the automatic control mode is indicated as “time” from the port table, and gives the instruction for all the extracted ports.

A fifth exemplary example of the present invention is a power supply system according to the first through the third exemplary examples, wherein:

the server includes:
a port table storing therein a port number, an IP address, an extension number, a user's name, an automatic control mode, and the IP address of a personal computer; and
an automatic control table storing therein a time at which control is executed, a target port, and a content of the control; and
the server is configured to:
retrieve, from the port table, the IP address of a personal computer used by the same user as a user of an IP telephone terminal connected to a port in which the automatic control mode is indicated as “cooperation with PC”;
confirm whether or not the personal computer having the IP address is active;
determine that the user is absent when the corresponding personal computer does not respond and a given period of time has elapsed or determine that the user is present when there is a response, and
switching the PoE power supply to the corresponding IP telephone terminal based on a result of the determination.

A sixth exemplary example of the present invention is a power supply system according to any one of the first through the third exemplary examples, wherein;

the server includes;
a port table storing therein a port number, an IP address, an extension number, a user's name, an automatic control mode, and the IP address of a personal computer; and
an automatic control table storing therein a time at which control is executed, a target port, and a content of the control; and

the server does not perform automatic control of the PoE power supply to a port in which the automatic control mode is indicated as “main number” because the port is connected to an always available IP telephone terminal,

A seventh exemplary example of the present invention is a server, which is used in a power feed system, the power feed system comprising: a device connected to a LAN, which receives electric power from the LAN; and a LAN switch connected to the LAN, which turns on/off PoE power supply to the device,

the server automatically instructing the LAN switch to provide the PoE power supply by specifying a time.

An eighth exemplary example of the present invention is a server, which is used in a power feed system, the power feed system comprising: a device connected to a LAN, which receives electric power from the LAN; and a LAN switch connected to the LAN, which switches PoE power supply to the device,

the server estimating an attended/unattended state of a user, and automatically instructing the LAN switch to provide the PoE power supply.

A ninth exemplary example of the present invention is a server, which is used in a power feed system, the power feed system comprising: a device connected to a LAN, which receives electric power from the LAN; and a LAN switch connected to the LAN, which turns on/off PoE power supply to the device,

the server allowing a user to manually instruct the LAN switch to provide the PoE power supply.

A tenth exemplary example of the present invention is a server according to any one of the seventh through the ninth exemplary examples, comprising:

a port table storing therein a port number, an IP address, an extension number, a user's name, an automatic control mode, and the IP address of a personal computer; and

an automatic control table storing therein a time at which control is executed, a target port, and a content of the control,

the server extracting, when the port number is not specified in the automatic control table, ports in each of which the automatic control mode is “time” from the port table, and giving the instruction for all the extracted ports.

An eleventh exemplary example of the present invention is a server according to any one of the seventh through the ninth exemplary examples, comprising:

a port table storing therein a port number, an IP address, an extension number, a user's name, an automatic control mode, and the IP address of a personal computer; and

an automatic control table storing therein a time at which control is executed, a target port, and a content of the control,

the server being configured to:
retrieve, from the port table, the IP address of a personal computer used by the same user as a user of an IP telephone terminal connected to the port in which the automatic control mode is “interlock with PC”;
confirm whether or not the personal computer having the IP address is active;
determine that the user is absent when the corresponding personal computer does not respond and a given period of time has elapsed or determine that the user is present when there is a response; and
switch the PoE power supply to the corresponding IP telephone terminal based on a result of the determination.

A twelfth exemplary example of the present invention is a server according to any one of the seventh through the ninth exemplary examples, comprising:

a port table storing therein a port number, an IP address, an extension number, a user's name, an automatic control mode, and the IP address of a personal computer; and

an automatic control table storing therein a time at which control is executed, a target port, and a content of the control,

the server not performing automatic control of the PoE power supply to a port in which the automatic control mode is indicated as “main number” because the port is connected to an always available IP telephone terminal.

A thirteenth exemplary example of the present invention is a power supply method, comprising, when switching PoE power supply to a device which receives electric power from a LAN by a LAN switch, automatically instructing the LAN switch to provide the PoE power supply by specifying a time.

A fourteenth exemplary example of the present invention is a power supply method, comprising, when turning on/off PoE power supply to a device which receives electric power from a LAN by a LAN switch, estimating an attended/unattended state of a user, and automatically instructing the LAN switch to provide the PoE power supply.

A fifteenth exemplary example of the present invention is a power supply method, comprising, when switching PoE power supply to a device which receives electric power from a LAN by a LAN switch, manually instructing, by a user, the LAN switch to provide the PoE power supply.

A sixteenth exemplary example of the present invention is a power supply method according to any one of the thirteenth to the fifteenth exemplary examples, further comprising:

extracting, when a port number is not specified in an automatic control table storing therein a time at which control is executed, a target port, and a content of the control, ports in each of which an automatic control mode is indicated as “time” from a port table storing therein a port number, an IP address, an extension number, a user's name, the automatic control mode, and an IP address of a personal computer; and

giving the instruction for all the extracted ports.

A seventeenth exemplary example of the present invention is a power supply method according to any one of thirteenth to the fifteenth exemplary examples, further comprising:

retrieving, from a port table storing therein a port number, an IP address, an extension number, a user's name, an automatic control mode, and the IP address of a personal computer, the IP address of a personal computer used by the same user as a user of an IP telephone terminal connected to a port in which the automatic control mode is indicated as “cooperation with PC”;

confirming whether or not the personal computer having the IP address is active;

determining that the user is absent when the corresponding personal computer does not respond to and a given period of time has elapsed or determining that the user is present when there is a response; and

switching the PoE power supply to the corresponding IP telephone terminal based on a result of the determination.

An eighteenth exemplary example of the present invention is a power supply method according to any one of the thirteenth to the fifteenth exemplary examples, wherein automatic control of the PoE power supply to a port in which the automatic control mode is “representative” is not performed because the port is connected to an always available IP telephone terminal.

A nineteenth exemplary example of the present invention is a program, which causes a computer to execute the procedure of, when a server switches PoE power supply to a device which receives electric power from a LAN by a LAN switch, automatically instructing, by the server, the LAN switch to provide the PoE power supply by specifying a time.

A twentieth exemplary example of the present invention is a program, which causes a computer to execute the procedure of, when a server switches PoE power supply to a device which receives electric power from a LAN by a LAN switch, estimating, by the server, an attended/unattended state of a user, and automatically instructing the LAN switch to provide the PoE power supply.

A twenty-first exemplary example of the present invention is a program, which causes a computer to execute the procedure of, when a server switches PoE power supply to a device which receives electric power from a LAN by a LAN switch, allowing, by the server, a user to manually instruct the LAN switch to provide the PoE power supply.

A twenty-second exemplary example of the present invention is a program according to any one of the nineteenth to the twenty-first exemplary examples, which further causes the computer to execute the procedures of:

extracting, by the server, when a port number is not specified in an automatic control table storing therein a time at which control is executed, a target port, and a content of the control, ports in each of which an automatic control mode is indicated as “time” from a port table storing therein a port number, an IP address, an extension number, a user's name, the automatic control mode, and an IP address of a personal computer, and

giving, by the server, the instruction for all the extracted ports.

A twenty-third exemplary example of the present invention is a program according to any one of the nineteenth to the twenty-first exemplary examples, which further causes the computer to execute the procedures of:

retrieving, by the server, from a port table storing therein a port number, an IP address, an extension number, a user's name, an automatic control mode, and the IP address of a personal computer, the IP address of a personal computer used by the same user as a user of an IP telephone terminal connected to a port in which the automatic control mode is “interlock with PC”;

confirming, by the server whether or not the personal computer having the IP address is active;

determining, by the server, that the user is absent when the corresponding personal computer does not respond and a given period of time has elapsed or determining that the user is present when there is a response; and

switching, by the server, the PoE power supply to the corresponding IP telephone terminal based on a result of the determination.

A twenty-fourth exemplary example of the present invention is a program according to any one of the nineteenth to the twenty-first exemplary examples, which further causes the computer to execute the procedure of not performing, by the server, automatic control of the PoE power supply to a port in which the automatic control mode is “representative” because the port is connected to an always available IP telephone terminal.

A twenty-fifth exemplary example of the present invention is a storage medium, which stores therein the program according to any one of the nineteenth to the twenty-fourth exemplary examples

While the present invention has been particularly shown and described with reference to exemplary embodiments thereof the present invention is not limited to these embodiments it twill be understood by those of ordinary skill in the art that various changes in form and detail may be made therein without departing from the spirit and scope of the present invention as defined by the claims.

What is claimed is:

1. A power supply system, comprising:
a device which is connected to a LAN and which is powered through the LAN;
a) a LAN switch which is connected between the LAN and the device and which switches Power-over-Ethernet (PoE) power supply to the device; and
a server which controls the LAN switch to determine whether or not the LAN switch performs the PoE power supply to the device.

2. A power supply system as claimed in claim 1 wherein:
the server monitors a predetermined time to send the LAN switch instructions of performing the PoE power supply at the predetermined time.

3. A power supply system as claimed in claim 1, wherein:
the server monitors a predetermined time to send the LAN switch instructions of interrupting the PoE power supply at the predetermined time.

4. A power supply system as claimed in claim 1, wherein:
the server monitors whether or not the device is being used to send the LAN switch instructions of interrupting the PoE power supply to the device.

5. A power supply system as claimed in claim 1, wherein:
the server is manually operated to perform the PoE power supply to the device.

6. A power supply system according to claim 1, wherein:
the server includes:
a port table storing therein a port number, an IP address, an extension number a user's name, an automatic control mode, and the IP address of a personal computer; and
an automatic control table storing therein a time at which control is executed, a target port, and a content of the control;
wherein the server determines whether or not the PoE power supply is performed with reference to the port table and the automatic control table.

7. A server comprising;
a controller unit which makes a decision about whether or not PoE power supply is to be performed; and
an interface circuit which sends a LAN switch a control instruction of indicating whether or not the PoE power supply is performed.

8. A server as claimed in claim 7, wherein,
the controller unit comprises a clock unit which monitors a predetermined time to supply the interface circuit with the control instruction of performing the PoE power supply at the predetermined time and to send the control instruction to the LAN switch.

9. A server as claimed in claim 7, wherein:
the controller unit comprises a detection unit which detects whether or not a user is attended/unattended to a user device, to interrupt the PoE power supply on detecting that the user is unattended to the user device.

10. A server as claimed in claim 7, wherein:
the controller unit comprises a manual operation detection unit which detects whether or not a manual operation is indicated to interrupt the PoE power supply when the manual operation is carried out.

11. A server as claimed in claim 7, wherein:
the server includes:
a port table storing therein a port number, an IP address, an extension number, a user's name, an automatic control mode, and the IP address of a personal computer; and
an automatic control table storing therein a time at which control is executed, a target port, and a content of the control;
wherein the server determines whether or not the PoE power supply is performed with reference to the port table and the automatic control table.

12. A power supply method of performing PoE power supply through a LAN to a user device, comprising:
in a server, making a decision about whether or not PoE power supply is to be performed;
informing a LAN switch of performing the PoE power supply; and
in the LAN switch, switching the PoE power supply to control the PoE power supply to a user device through the LAN.

13. A power supply method as claimed in claim 12, further comprising:
in the server, storing a predetermined time;
monitoring whether or not a monitored time arrives at the predetermined time, to make the decision of performing the PoE power supply when the monitored time arrives at the predetermined time.

14. A power supply method as claimed in claim 12, further comprising:
in the server, detecting whether or not the user device is being used by a user to make the decision of performing the PoE power supply to the user device when the user device is being used; and, otherwise, to make the decision of not performing the PoE power supply.

15. A power supply method as claimed in claim 12, further comprising:
in the server, detecting whether or not a manual operation is executed, to make the decision of not performing the PoE power supply when the manual operation is executed.

16. A power supply method as claimed in claim 12, further comprising:
in the server, presuming an attended/unattended state of a user to instruct the LAN switch to perform the PoE power supply only when the attended state is presumed.

17. A power supply method as claimed in claim 12, wherein:
the server includes:
a port table storing therein a port number, an IP address, an extension number, a user's name, an automatic control mode, and the IP address of a personal computer; and
an automatic control table storing therein a time at which control is executed, a target port, and a content of the control;
wherein the server determines whether or not the PoE power supply is performed with reference to the port table and the automatic control table.

18. A power supply method according to claim 17, further comprising:
retrieving, from the port table, the IP address of a personal computer used by the same user as a user of an IP telephone terminal connected to a port in which the automatic control mode is indicated as “COOPERATION WITH PC”;
confirming whether or not the personal computer having the IP address is active;
determining that the user is unattended when the corresponding personal computer does not respond to and a given period of time has elapsed or determining that the user is attended when there is a response; and
powering on/off the PoE power supply to the corresponding IP telephone terminal based on a result of the determination.

19. A power supply method according to claim 18, wherein automatic control of the PoE power supply to a port in which the automatic control mode is indicated as “MAIN NUMBER” is not performed.

20. A computer-readable program product, which causes a POE server to perform PoE power supply to a user device through a LAN switch and a LAN cable, comprising:
making a decision about whether or not the PoE power supply is to be performed; and
informing the LAN switch of performing the PoE power supply when the PoE power supply is performed.

21. A computer-readable program product according to claim 20, further comprising:
monitoring a time; and
detecting whether or not a monitored time arrives at a predetermined time to make the decision of performing the PoE power supply and to send a control instruction of performing the PoE power supply to the user device when the monitored time arrives at the predetermined time.

22. A computer-readable program product according to claim 20, further comprising;
presuming an attended/unattended state of the user device; and
detecting whether a user is attended or unattended to the user device;
instructing the LAN switch to perform the PoE power supply when the attended state is presumed, so as to make the decision of performing the PoE power supply.

23. A computer-readable program product according to claim 20, further comprising:
detecting whether or not a manual operation is executed for performing the PoE power supply; and
instructing the LAN switch not to perform the PoE power supply when the manual operation is detected, so as to make the decision of not performing the PoE power supply.

24. A computer-readable program product according to claim 20, the server includes:
a port table storing therein a port number, an IP address, an extension number, a user's name, an automatic control mode, and the IP address of a personal computer; and
an automatic control table storing therein a time at which control is executed, a target port, and a content of the control;
wherein the computer-readable program product further comprises:
determining whether or not the PoE power supply is performed with reference to the port table and the automatic control table.

25. A computer-readable program product according to claim 20, comprising:
retrieving no indication of the port number from the port table;
detecting from the automatic control port, that the automatic control mode is indicated as “TIME”; and
performing the PoE power supply to all of ports.

26. A computer-readable program product according to claim 20, wherein automatic control of the PoE power supply to a port in which the automatic control mode is indicated as “MAIN NUMBER” is not performed.
